(19) United States
(12) Patent Application Publication
(10) Pub. No.: US 2016/0291781 A1
(43) Pub. Date: Oct. 6, 2016

(54) ARRAY SUBSTRATE AND DISPLAY DEVICE

(71) Applicants: Shanghai Tianma Micro-Electronics Co., Ltd., Shanghai (CN); Tianma Micro-Electronics Co., Ltd., Shenzhen (CN)

(72) Inventors: Chunmei He, Shanghai (CN); Lingxiao Du, Shanghai (CN); Qijun Yao, Shanghai (CN); Yong Yuan, Shanghai (CN); Quanpeng Yu, Shanghai (CN)

(21) Appl. No.: 14/977,276

(22) Filed: Dec. 21, 2015

(30) Foreign Application Priority Data
Apr. 1, 2015 (CN) 201510152689.4

(51) Int. Cl. G06F 3/041; G06F 3/044

(52) U.S. Cl. CPC G06F 3/0416; G06F 3/0412; G06F 3/044; G06F 2203/04103; G06F 2203/04111

(57) ABSTRACT

An array substrate and a display device are provided. The array substrate includes a display area and a frame area. The frame area surrounds the display area on four sides of top, bottom, left and right; touch-control electrodes arranged in an array are provided in the display area, and the respective touch-control electrodes are insulated from each other; touch-control electrodes are also provided in the frame area on at least one side; and each of the touch-control electrodes is connected to a touch-control driver circuit through a touch-control wire. Touch-control electrodes arranged in an array are provided not only in the display area, but also in the frame area, thus when the user touches the edges such as the frame area, the location of touch can be detected sensitively through touch-control electrodes provided in the frame area.

### CROSS REFERENCE TO RELATED APPLICATION

The present application claims the priority to Chinese Patent Application No. 201510152689.4, entitled “ARRAY SUBSTRATE AND DISPLAY DEVICE”, filed on Apr. 1, 2015 with the State Intellectual Property Office of People's Republic of China, which is incorporated herein by reference in its entirety.

### TECHNICAL FIELD OF THE INVENTION

The disclosure relates to the field of touch screen technology, and in particular to an array substrate and a display device.

### BACKGROUND OF THE INVENTION

In conventional technology, touch screens, commonly capacitive touch screens, are widely used in display devices. The touch screen usually includes a frame area and a display area, the frame area which does not display surrounds the display area.

Touch-control electrodes are provided in the display area, to realize the touch-control function and detect the location of touch.

When a user touches the frame area, or touches at a location between the frame area and the display area, a phenomenon of insensitive response to the touch may be caused.

Thus, there is a need to provide an array substrate, to allow the location of touch to be detected sensitively even when the user touches the frame area or a location between the frame area and the display area.

### SUMMARY OF THE INVENTION

This disclosure provides an array substrate and a display device to allow the location of touch to be detected sensitively when the user touches the frame area or a location between the frame area and the display area.

An array substrate is provided according to the embodiment of the disclosure. The array substrate includes a display area and a frame area. The frame area surrounds the display area on four sides of top, bottom, left and right. Touch-control electrodes are arranged in an array and are provided in the display area. Respective touch-control electrodes are insulated from each other, and touch-control electrodes are also provided in the frame area on at least one side. Each of the touch-control electrodes is connected to a touch-control driver circuit through a touch-control wire.

A display device including the above array substrate is further provided according to an embodiment of the disclosure.

### BRIEF DESCRIPTION OF THE DRAWINGS

In order to illustrate the technical solutions according to the embodiments of the disclosure more clearly, the drawings are described briefly hereinafter. The drawings described hereinafter are only some embodiments of the present disclosure, and other drawings may be obtained by those skilled in the art according to the provided drawings without any creative effort.

FIG. 1 is a diagram of an array substrate according to an embodiment of the disclosure;

FIG. 2 is a diagram of an array substrate according to another embodiment of the disclosure;

FIG. 3 is a sectional view of an array substrate according to an embodiment of the disclosure;

FIG. 4 is a sectional view of an array substrate according to another embodiment of the disclosure;

FIG. 5 is a top view of an array substrate according to yet another embodiment of the disclosure;

FIG. 6 is a sectional view of an array substrate according to yet another embodiment of the disclosure;

FIG. 7 is a sectional view of an array substrate according to yet another embodiment of the disclosure;

FIG. 8 is a sectional view of an array substrate according to yet another embodiment of the disclosure;

FIG. 9a is a top view of an array substrate according to an embodiment of the disclosure;

FIG. 9b is a top view of an array substrate according to another embodiment of the disclosure;

FIG. 9c is top view of an array substrate according to yet another embodiment of the disclosure; and

FIG. 10 is a diagram of a display device according to an embodiment of the disclosure.

### DETAILED DESCRIPTION OF THE INVENTION

Hereinafter, the technical solutions in the embodiments of the present disclosure are described clearly and completely in conjunction with the drawings in the embodiments of the present disclosure. The described embodiments are only a few rather than all of the embodiments of the present disclosure. All the other embodiments obtained by those skilled in the art based on the embodiments of the present disclosure without any creative effort fall within the scope of protection of the disclosure.

To make the above objectives, features and merits of the disclosure easier to be understood, specific embodiments of the disclosure are illustrated in detail in conjunction with the drawings.

To solve the problem of insensitivity of touch-control in the frame area, an array substrate is provided. The array substrate includes a display area and a frame area, and the frame area surrounds the display area on four sides: top, bottom, left and right. Touch-control electrodes arranged in an array are provided in the display area, where the touch-control electrodes are insulated from each other; and touch-control electrodes are also provided in the frame area on at least one side. Each of the touch-control electrodes is connected to a touch-control driver circuit through a touch-control wire.

It should be noted that, touch-control electrodes are also provided in the frame area, such that when the user touches the edge section such as the frame area, the location of touch may be detected sensitively through the touch-control electrodes provided in the frame area. The touch-control electrodes further allow the location of touch to be detected sensitively when the user touches the frame area or a location between the frame area and the display area.

In conventional technology, there is no touch-control electrode in the frame area, when the user touches the frame area, only the edge section of the touch-control electrodes in the display area near the frame area would be affected. For example, for the outermost row or column of touch-control electrodes in the display area, there is no touch-control electrode on the outside of the touch-control electrodes on the edge, thus the calculated location of touch is inaccurate, and the accuracy is lower than that when the user touches a location in the middle of the display area. In the touch detection the location of touch is determined through calculating the variation of capacitance of the touch-control electrode. For example, four touch-control electrodes are touched simultaneously, if the variations of capacitances of the four touch-control electrodes are the same, it may be determined that the precise location of touch is at the central location of the four touch-control electrodes. However, in a case that the actual location of touch is on the edge of the display area, since there are fewer touch-control electrodes in such area, the detected location of touch is inaccurate.

Understandably, the touch-control electrodes in the array substrate according to the embodiment of the disclosure may be applied to the self-capacitive touch-control.

The array substrate according to the disclosure is described in detail hereinafter in conjunction with the drawings.

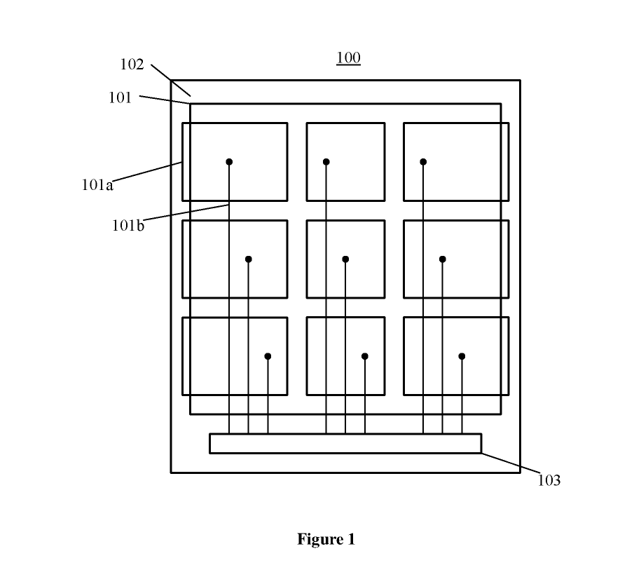

Referring to FIG. 1, a diagram of an array substrate according to an embodiment of the disclosure is shown.

The array substrate 100 includes a display area 101 and a frame area 102.

Touch-control electrodes 101a are arranged in an array and are provided in the display area 101. It should be noted that, according to an embodiment of the invention, the touch-control electrodes 101a on the edge of display area 101 extend to cover the frame area 102, as shown in FIG. 1.

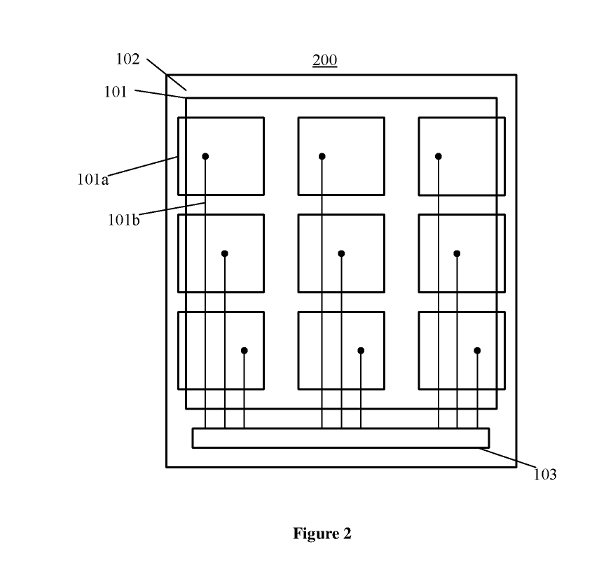

In one embodiment, the touch-control electrodes 101a on the edge may have a larger area than the touch-control electrodes not on the edge, as shown in FIG. 1. In an alternate embodiment, touch-control electrodes 101a on the edge may have the same area as the touch-control electrodes not on the edge, as shown in FIG. 2.

Referring back to FIG. 1, each of the touch-control electrodes 101a is connected to a touch-control drive circuit 103 through touch-control wires 101b.

It should be noted that, in a case that touch-control electrodes 101a are not in the same layer as touch-control wires 101b, the projection the touch-control electrodes 101a overlaps the projection of the touch-control wires 101b in the direction perpendicular to the array substrate. In some embodiments, via holes are used to electrically connect touch-control electrodes 101a to touch-control wires 101b.

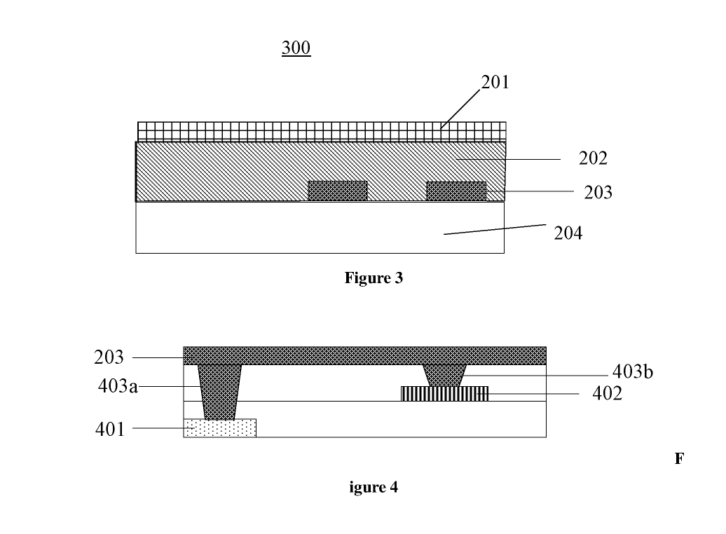

Referring to FIG. 3, a sectional view of an array substrate according to an embodiment of the disclosure is shown.

The array substrate 300 according to an embodiment of the disclosure further includes a substrate 204, a pixel electrode 203 and a common electrode 201, where the pixel electrode 203 is located between the substrate 204 and the common electrode 201, and the common electrode 201 is used as the touch-control electrode.

In a case that the common electrode is used as the touch-control electrode, the common electrode is partitioned into a plurality of independent units, each unit is a touch-control electrode, and the touch-control electrodes are insulated from each other. Thus the process and cost of providing the touch-control electrodes and common electrodes separately are saved. In a case that the common electrode is used as the touch-control electrode when the array substrate is in a display status, a display common signal is inputted to the common electrode, and when the array substrate is in a touch detection status, a touch-control signal is inputted to the common electrode.

It should be noted that a first insulating layer 202 is provided between the pixel electrode 203 and common electrode 201.

FIG. 3 shows an array substrate with the common electrode 201 on top (top-com). According to an embodiment, the array substrate further includes a gate drive circuit provided in the frame area, where the gate drive circuit includes a plurality of bridges, and the bridges are fabricated in the same layer as the pixel electrodes.

Referring to FIG. 4, a sectional view of frame area of an array substrate according to an embodiment of the disclosure is shown.

In the gate drive circuit, the bridges are needed to connect components or wires on different metal layers together so that the projections of the components and wires on the array substrate do not overlap. As a result, electrical connections cannot be created using via holes. Bridges are fabricated through the pixel electrode layer according to the embodiment, to realize the electrical connection of components and wires in the gate drive circuit.

As shown in FIG. 4, the first pier 403a and the second pier 403b are both fabricated in the same layer as the pixel electrode 203.

Taking the case where components and wires are located in data line layer 401 and gate line layer 402 respectively, the bridge composed of first pier 403a and second pier 403b may be used to establish an electrical connection between data layer 401 and gate line layer 402.

According to an embodiment, the touch-control electrodes in the frame area are formed through the extension of the touch-control electrodes in the display area (i.e. the touch-control electrodes in the frame area are formed by using the common electrode layer). Since the common electrodes are used as the touch-control electrodes, there is no need to provide touch-control electrodes in the frame area separately. Instead just the common electrode layer in the frame area is used and fabrication process and cost are saved.

In addition, since touch-control electrodes in the frame area are fabricated through the common electrode layer, bridges in the frame area may be fabricated through the pixel electrode layer. Thus the common electrode layer and pixel electrode layer are efficiently utilized in the frame area. In the frame area, there are touch-control electrodes extending from the display area, thus, the precise location of touch can be detected precisely when the user touches the edge of the display area or the frame area.

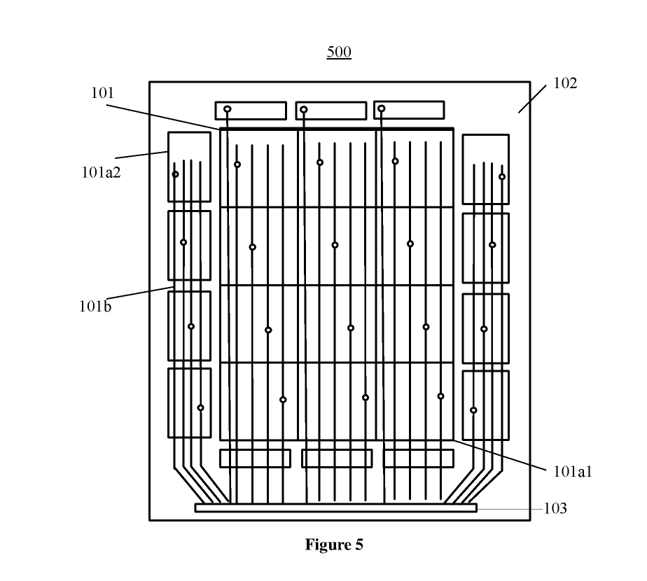

Referring to FIG. 5, a top view of an array substrate according to an embodiment of the disclosure is shown.

An array substrate 500 is provided according to an embodiment of the disclosure, where the touch-control electrode includes a first touch-control electrode 101a1 located in the display area 101 and a second touch-control electrode 101a2 located in the frame area, and first touch-control electrode 101a1 is insulated from the second touch-control electrode 101a2.

According to an embodiment, the first touch-control electrode 101a1 in the display area and the second touch-control electrode 101a2 in the frame area are independent of each other.

In the case that the first touch-control electrode 101a1 and the second touch-control electrode 101a2 in the frame area are provided separately, the second touch-control electrode 101a2 in the frame area has a smaller area than the first touch-control electrode 101a1 in the display area. In some embodiments, the reserved area for the frame area is limited and the area of the second touch-control electrode 101a2 provided in the frame area is also smaller. The relationship between sizes of the first touch-control electrode and the second touch-control electrode is no limited herein.

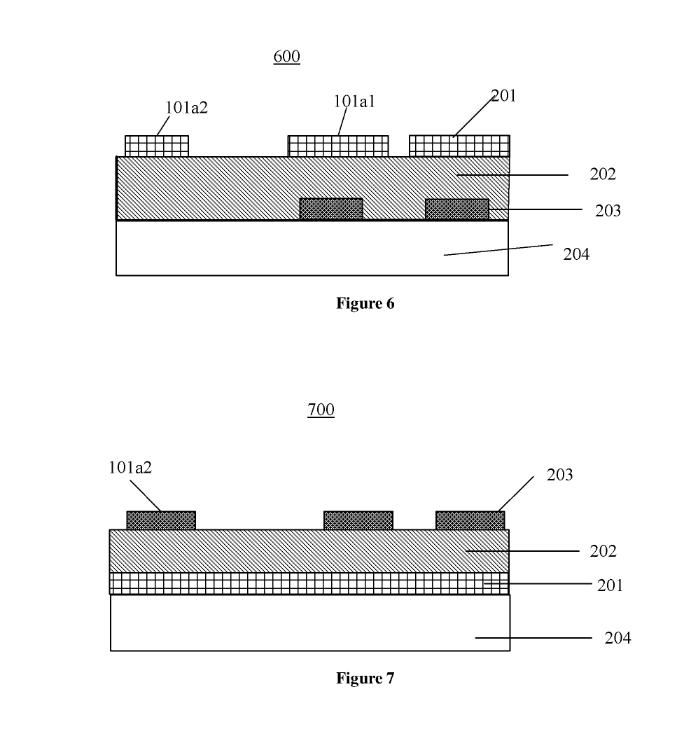

Referring to FIG. 6, a sectional view of an array substrate according to another embodiment of the disclosure is shown.

The array substrate 600 according to an embodiment further includes a substrate 204, a pixel electrode 203, and a common electrode 201 where the pixel electrode 203 is located between the substrate 204 and the common electrode 201. The common electrode 201 is used as the first touch-control electrode 101a1, and the second touch-control electrode 101a2 is fabricated in the same layer as the common electrode 201.

In addition, the bridge according to an embodiment may be fabricated in the same layer as the pixel electrode, as shown in FIG. 4, (i.e., the array substrate according to the embodiment further includes a gate drive circuit provided in the frame area, where the gate drive circuit includes a plurality of bridges, and the bridges are fabricated in the same layer as the pixel electrode).

According to an embodiment, the second touch-control electrodes 101a2 are provided in the frame area independently, and the second touch-control electrodes 101a2 in the frame area are formed by using the common electrode layer in the frame area. Since the common electrode is used as the touch-control electrode, there is no need to provide touch-control electrode in the frame area separately, thus fabrication process and cost are saved.

In addition, since touch-control electrodes in the frame area are fabricated through the common electrode layer, bridges in the frame area may be fabricated through the pixel electrode layer, thus the common electrode layer and pixel electrode layer are efficiently utilized in the frame area. There are second touch-control electrodes 101a2 provided independently in the frame area, thus, the precise location of touch can be detected precisely when the user touches the edge of the display area or the frame area.

Referring to FIG. 7, a sectional view of an array substrate according to another embodiment of the disclosure is shown.

The array substrate 800 according to the embodiment further includes a substrate 204, a pixel electrode 203 and a common electrode 201, where the common electrode 201 is located between the substrate 204 and the pixel electrode 203, the common electrode 201 is reused as the first touch-control electrode, and the second touch-control electrode 101a2 is fabricated in the same layer as the pixel electrode 203.

In addition, according to an embodiment, the array substrate further includes a gate drive circuit provided in the frame area, where the gate drive circuit includes a plurality of bridges, and the bridges are fabricated in the same layer as the common electrode.

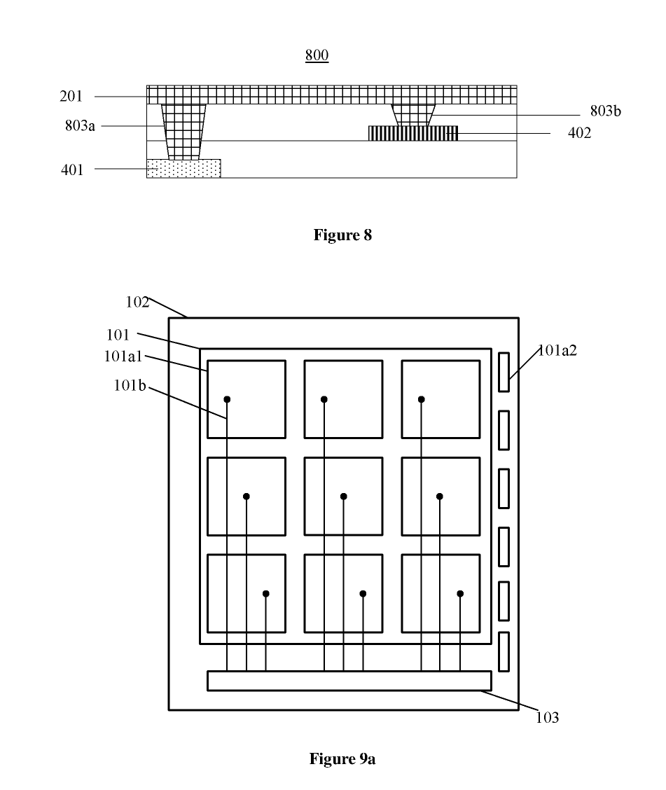

Referring to FIG. 8, bridges are needed to connect components or wires on different metal layers together, for the projections of the components and wires on the array substrate do not overlap and thus those cannot be electrically connected together through via holes. Bridges are fabricated through the pixel electrode layer according to the embodiment, to create the electrical connection of components and wires in the gate drive circuit.

As shown in FIG. 8, the first pier 803a and the second pier 803b are both fabricated in the same layer as the pixel electrode 203.

Taking the instance where components and wires are located in data line layer 401 and gate line layer 402. The bridge composed of the first pier 803a and the second pier 803b may be used to realize the electrical connection between the data line layer 401 and gate line layer 402.

According to an embodiment, the second touch-control electrodes 101a2 are provided in the frame area independently, and the second touch-control electrodes 101a2 in the frame area are formed by using the pixel electrode layer in the frame area. Since the common electrode is used as the touch-control electrode, there is no need to provide touch-control electrode in the frame area separately, thus fabrication process and cost are saved.

In addition, since touch-control electrodes in the frame area are fabricated through the common electrode layer, bridges in the frame area may be fabricated through the pixel electrode layer, thus the common electrode layer and pixel electrode layer are efficiently utilized in the frame area. The second touch-control electrodes 101a2 provided independently in the frame area, thus, the precise location of touch can be detected precisely when the user touches the edge of the display area or the frame area.

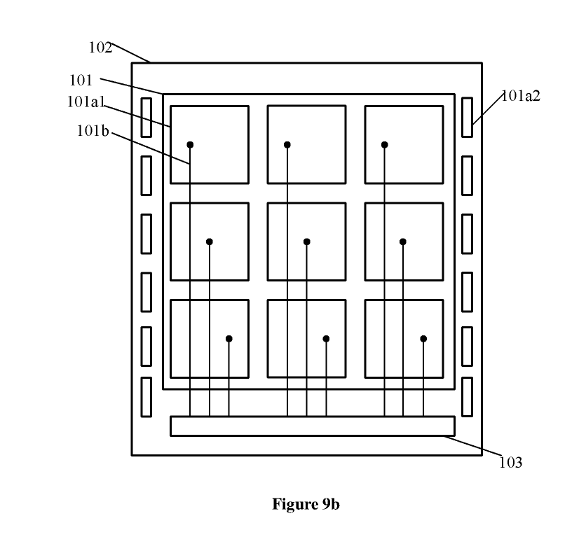

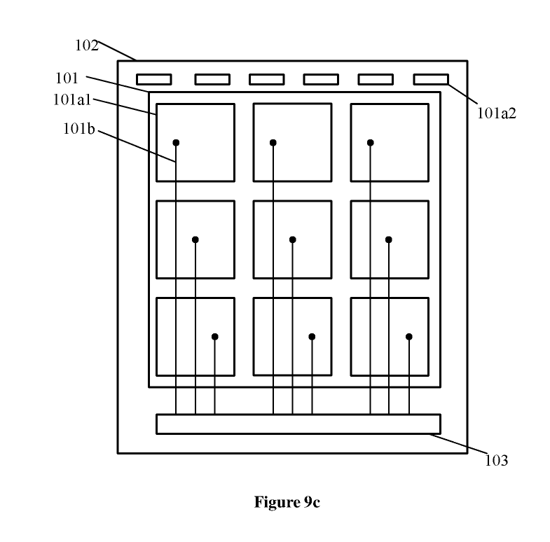

It should be noted that, for the array substrates according to the embodiments, any one of the following modes for disposing the touch-control electrodes in the frame area may be adopted. The touch-control electrodes are provided on the top side of the frame area; or, the touch-control electrodes are provided on the left side of the frame area; or, the touch-control electrodes are provided on the right side of the frame area, as shown in FIG. 9a; or, the touch-control electrodes are provided on the left and right side of the frame area, as shown in FIG. 1 and FIG. 2; or, the touch-control electrodes are provided on the top, left and right side of the frame area, as shown in FIG. 5.

It should be noted that, in a case that the size of the touch-control electrode in the display area is smaller than 8 mm by 8 mm, it is preferable that the size of the touch-control electrode in the frame area is consistent with the size of the touch-control electrode in the display area.

It should be noted that, since the shape of the touch-control electrode is not necessarily a square. In some embodiments, the shape may be rectangle, or even an irregular shape such as polygon, thus the limitation for the size of the touch-control electrode defined above refers to the case that the maximum size of the touch-control electrode in the lengthwise direction or in the widthwise direction is smaller than the value 8 mm. For example, if the shape of the touch-control electrode in the display area is a rectangle, the size 6 mm by 8 mm of the touch-control electrode is smaller than 8 mm by 8 mm. The shape of the touch-control electrode in the frame area is also a rectangle, and the specific size is 2 mm by 8 mm (i.e., the width of touch-control electrode in the frame area is consistent with the width of touch-control electrode in the display area). In some embodiments, it is possible that the length of touch-control electrode in the frame area is consistent with the length of touch-control electrode in the display area.

8 mm by 8 mm is generally the size of coverage by a human finger when touching the display panel. If the size of touch-control electrode in the display area is smaller than the area touched by a human finger, it is adequate that the size of touch-control electrode in the frame area is consistent with the size of touch-control electrode in the display area.

It should be noted that, in above description, the size of touch-control electrode provided in the frame area is consistent with the size of touch-control electrode provided in the display area.

There are two kinds of situations where the size of touch-control electrode provided in the frame area is consistent with the size of touch-control electrode provided in the display area. In the first situation, as shown in FIG. 5, the length (in the row direction) of touch-control electrodes provided on the top side and lower side of the frame area are consistent with the length of touch-control electrode in the display area. In the second situation, as shown in FIG. 5, the width (in the column direction) of touch-control electrodes provided on the left side and right side of the frame area are consistent with the width of touch-control electrode in the display area.

In another situation, if the size of touch-control electrode in the display area is larger than the area touched by a human finger, it is preferable that the size of touch-control electrode in the frame area is smaller than the size of touch-control electrode in the display area. In other words, the size of touch-control electrode in the display area may be larger than 8 mm by 8 mm. In this situation, as shown in FIG. 9a, the size of touch-control electrode provided in the frame area may be smaller than the size of touch-control electrode provided in the display area.

If the size of touch-control electrode in the display area is larger than the area touched by a finger, the size of touch-control electrode in the frame area may be smaller than the size of touch-control electrode in the display area, thus the sensitivity of touch in the frame area and the precision of detection for the location of touch may be achieved Similarly, if the size of touch-control electrode in the display area is smaller than the area touched by a finger, the size of touch-control electrode in the frame area may be consistent with the size of touch-control electrode in the display area, thus the sensitivity of touch in the frame area and the precision of detection for the location of touch may be achieved.

It should be noted that, as shown in FIG. 9b, the number of touch-control electrodes in each column provided on the left side or on the right side of the frame area may be greater than the number of touch-control electrodes in each column provided in the display area.

It should be noted that, as shown in FIG. 9c, the number of touch-control electrodes in each row provided on the top side of the frame area may be greater than the number of touch-control electrodes in each row provided in the display area.

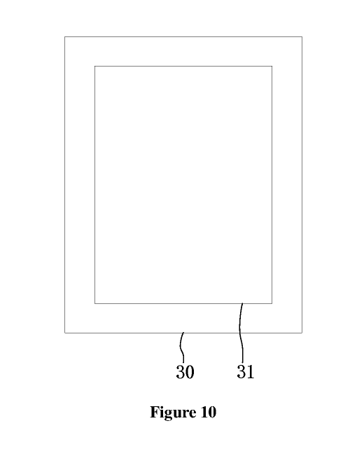

A display device is further provided according to the embodiment of the disclosure, as shown in FIG. 10. The display device includes the array substrates according to any one of the above embodiments.

The display device 30 includes an array substrate 31, and may further include a drive circuit and other components used to support the normal operation of display device 30.

The array substrate 31 is the display panel according to any one of the above embodiments. The display device 30 may be one of cell phone, desktop computer, notebook computer, tablet computer, electronic paper, and the like.

According to the embodiment, since touch-control electrodes are provided in the frame area corresponding to the display panel, the specific location of touch can be detected precisely when the user touches the edge of the display area or the frame area. It should be noted that, touch-control electrodes in the frame area may be independent touch-control electrodes provided separately, or may be the extension of the touch-control electrodes in the display area. In a case that touch-control electrodes in the frame area are formed by using the common electrode layer, the pixel electrode layer in the frame area may be used to fabricate bridges of the gate drive circuit. In a case that touch-control electrodes in the frame area are formed by using the pixel electrode layer, the common electrode layer in the frame area may be used to fabricate bridges of the gate drive circuit, thus the common electrode layer and pixel electrode layer may be fully utilized.

The described embodiments are merely preferred embodiments of the disclosure, and are not intended to limit the disclosure in any form. The above preferred embodiments, which are used to describe the disclosure, are not meant to limit the invention. Using the above described method and technical content, those skilled in the art may make many possible changes and modifications to the technical solution of the disclosure, or revise the embodiments as equivalent embodiments of equivalent change, without departing from the scope of technical solution of the disclosure. Any simple change, equivalent replacement, and modification to the embodiments, without departing from the content of technical solution of the disclosure based on the essence of technology of the disclosure should fall in the scope of protection of the disclosure.

What is claimed is:

1. An array substrate comprising:
a display area;
a frame area, wherein the frame area surrounds all sides of the display area, and includes four sides, a top side, a bottom side, a right side and a left side;
touch-control electrodes arranged in an array in the display area, wherein the touch-control electrodes are insulated from each other;
wherein the touch-control electrodes are also arranged in the frame area on at least one side; and
each of the touch-control electrodes is connected to a touch-control driver circuit through a touch-control wire.

2. The array substrate according to claim 1, wherein the touch-control electrode is configured for self-capacitive touch-control.

3. The array substrate according to claim 1, wherein the touch-control electrodes on an edge of the display area extend to cover the frame area.

4. The array substrate according to claim 3, further comprising a substrate, a pixel electrode and a common electrode, wherein the pixel electrode is located between the substrate and the common electrode, and the common electrode is reused as the touch-control electrode.

5. The array substrate according to claim 4, further comprising a gate drive circuit in the frame area, wherein the gate drive circuit comprises a plurality of bridges, and the bridges are fabricated in a same layer as the pixel electrodes.

6. The array substrate according to claim 1, wherein the touch-control electrodes comprise a first touch-control electrode located in the display area and a second touch-control electrode located in the frame area, and first touch-control electrode is insulated from the second touch-control electrode.

7. The array substrate according to claim 6, further comprising a substrate, a pixel electrode and a common electrode, wherein the pixel electrode is located between the substrate and the common electrode, the common electrode is reused as the first touch-control electrode, and the second touch-control electrode is fabricated in a same layer as the common electrode.

8. The array substrate according to claim 7, further comprising a gate drive circuit provided in the frame area, wherein the gate drive circuit comprises a plurality of bridges, and the bridges are fabricated in a same layer as the pixel electrode.

9. The array substrate according to claim 6, further comprising a substrate, a pixel electrode and a common electrode, wherein the common electrode is located between the substrate and the pixel electrode, the common electrode is reused as the first touch-control electrode, and the second touch-control electrode is fabricated in a same layer as the pixel electrode.

10. The array substrate according to claim 9, further comprising a gate drive circuit provided in the frame area, wherein the gate drive circuit comprises a plurality of bridges, and the bridges are fabricated in a same layer as the common electrode.

11. The array substrate according to claim 1, wherein the touch-control electrode and the touch-control wire are in different layers, and a projection of the touch-control electrode and a projection of the touch-control wire in a direction perpendicular to the array substrate overlap with each other; and
the touch-control wire is connected to the touch-control electrode through a via hole.

12. The array substrate according to claim 1, wherein the touch-control electrodes are provided on a top side of the frame area; or
the touch-control electrodes are arranged on a left side of the frame area; or
the touch-control electrodes are arranged on a right side of the frame area; or
the touch-control electrodes are arranged on the top, left and right side of the frame area.

13. The array substrate according to claim 6, wherein size of the touch-control electrodes arranged in the frame area is consistent with size of the touch-control electrodes arranged in the display area.

14. The array substrate according to claim 13, wherein the size of the touch-control electrode is smaller than 8 mm*8 mm.

15. The array substrate according to claim 6, wherein size of the touch-control electrodes arranged in the frame area is smaller than size of the touch-control electrodes arranged in the display area.

16. The array substrate according to claim 15, wherein the size of the touch-control electrode is larger than 8 mm*8 mm.

17. The array substrate according to claim 15, wherein the number of touch-control electrodes in each column arranged on the left side or on the right side of the frame area is greater than the number of touch-control electrodes in each column arranged in the display area.

18. The array substrate according to claim 15, wherein the number of touch-control electrodes in each row arranged on the top side of the frame area is greater than the number of touch-control electrodes in each row arranged in the display area.

19. A display device comprising an array substrate, the array substrate comprising a display area and a frame area, wherein:
the frame area surrounds the display area including four sides of top, bottom, left and right;
touch-control electrodes arranged in an array are arranged in the display area, and the respective touch-control electrodes are insulated from each other; and the touch-control electrodes are also arranged in the frame area on at least one side; and
each of the touch-control electrodes is connected to a touch-control driver circuit through a touch-control wire.
